(19) United States
(12) Patent Application Publication
(10) Pub. No.: US 2014/0224009 A1
(43) Pub. Date: Aug. 14, 2014

(54) HIGH VELOCITY WIND SONDE

(71) Applicant: Glen J. Brown, Santa Cruz, CA (US)

(72) Inventor: Glen J. Brown, Santa Cruz, CA (US)

(73) Assignee: HDT EXPEDITIONARY SYSTEMS, Solon, OH (US)

(21) Appl. No.: 14/017,005

(22) Filed: Sep. 3, 2013

Related U.S. Application Data
(60) Provisional application No. 61/764,253, filed on Feb. 13, 2013.

(51) Int. Cl. G01W 1/08

(52) U.S. Cl. CPC G01W 1/08
USPC 73/170.28

(57) ABSTRACT

The present disclosure pertains to a high ballistic coefficient wind sonde device and a method of determining wind speed and wind direction measurements relative to altitude with a high velocity wind sonde device. The device includes a streamlined body including a first end, a second end, a longitudinal axis, and an internal cavity. A tail extension includes a first end that is connected to the body second end and a second end, wherein the tail extends along the longitudinal axis of the streamlined body. At least one pair of oppositely extending fins are mounted to the tail adjacent its second end. An electronic assembly is located in the internal cavity for generating wind and altitude data. A transmitting antenna is mounted to at least one of the body and the tail for transmitting the wind and altitude data generated by the electronic assembly.

This application claims priority from the U.S. Provisional Application Ser. No. 61/764,253 filed on Feb. 13, 2013, the subject matter of which is incorporated hereinto in its entirety.

### BACKGROUND

The present disclosure relates to a high ballistic coefficient wind sonde device for determining wind and altitude data. It finds particular application in conjunction with accurately dropping cargo from an aircraft into a desired drop zone, and will be described with particular reference thereto. However, it is to be appreciated that the present exemplary embodiment is also amenable to other like applications.

It is a common maneuver to drop cargo from an aircraft while the aircraft is in use at an altitude above the ground with the intention that the cargo land in a desired drop zone. However, after the cargo is discharged from the aircraft, environmental factors such as wind speed and wind direction may cause the cargo's trajectory to change and land at an undesired location. Determining an accurate trajectory and, hence, the optimum aerial release coordinates for a cargo drop depends on correctly determining the altitude and speed of the aircraft and the current wind speed and wind direction.

In a related field, smart bombs have been actively steered employing conventional television video camera or an infrared camera. Laser-guided technology is also known to guide smart bombs. The laser seeker includes an array of photo diodes that are sensitive to a particular frequency of laser light which is aimed at the target. However, these systems would be disadvantageous for cargo drops because they must maintain visual contact with the desired drop zone and would be inaccurate if clouds or other obstacles interrupt the signal of the trajectory path of the cargo.

It is known to use a control system having an inertial guidance system with a global positioning system (GPS) capability to guide cargo by interpreting the GPS position and tracking its path from launch. However, this technology still requires costly active steering technology which includes actuators that control the fins and/or parachutes of the cargo.

Another means for obtaining real-time wind data is proposed using light detection and ranging (LIDAR) technology with the system being installed on the drop aircraft. This approach is costly and requires modifications to the aircraft, and may be less effective in certain weather conditions.

All such cargo aerial delivery methods, with or without active controls, depend on accurate wind data for their delivery, accuracy and effectiveness.

Wind sonde devices such as radiosondes and rawinsondes have also been used for making measurements of the wind and the altitude. Radiosondes have been used to measure many atmospheric variables, while rawinsondes measure only wind. However, these devices are generally attached to balloons or parachutes and are configured to sample measurements as they slowly ascend or descend in the atmosphere. This information can be used to predict a trajectory of the cargo but it includes inaccuracies due to the slow sampling of raw data and the elapsed time.

A slowly descending wind sonde also reduces the efficiency and increases the risk of aerial delivery operations. Since the drop aircraft has traveled well beyond the drop zone by the time it can receive the wind data it must circle back, having revealed its intentions to enemy units on the ground by the time it is ready to release its cargo. Even using another aircraft to drop the wind sonde is highly observable and increases the risk to the drop aircraft.

Therefore, there remains a need for an improvement in wind velocity measurement technology that is designed to accurately and quickly measure wind and altitude data so that accurate trajectory and release coordinates can be calculated for the cargo. The data is sampled quickly and in real time and thus can be used to more accurately predict the desired trajectory of the cargo, which can be dropped from either the same aircraft that releases the drop-sonde or a following aircraft.

The present disclosure pertains to a device for the rapid determination of wind velocity at altitudes below the drop aircraft and to transmit that data back to the drop aircraft. The device should be compatible with existing aircraft systems without modification. Also, the device should be compatible with known delivery systems with unmanned aerial vehicles (UAVs) and small rocket boosters as additional delivery means.

### BRIEF DESCRIPTION

In one embodiment the present disclosure pertains to a high ballistic coefficient wind sonde device. The device including a streamlined body including a first end, a second end, a longitudinal axis, and an internal cavity. A tail includes a first end that is connected to the body second end and a second end, wherein the tail extends along the longitudinal axis of the streamlined body. At least two fins are mounted to the tail adjacent its second end. An electronic assembly is located in the internal cavity for generating wind and altitude data. A transmitting antenna is mounted in or to at least one of the body and the tail for transmitting the wind and altitude data generated by the electronic assembly.

In another embodiment of the present disclosure, a high ballistic coefficient wind sonde device for receiving and transmitting data is provided. The device includes a streamlined body arranged in an axially symmetric orientation having an internal cavity for containing an electronic assembly for generating wind and altitude data. The body includes a housing portion having a first end and an opposite second end such that a ballast weight is positioned towards the first end, and an elongated tail having a proximal end and a distal end, the proximal end of the elongated tail being attached to the second end of the housing portion, the housing portion has a greater radius than the tail. A plurality of fins are attached near the distal end of the tail. The electronic assembly includes a first circuit board having at least one tilt sensor, or lateral acceleration sensor for detecting an angle position of the body relative to a first axis and at least one roll/heading sensor for detecting an angle position of the body relative to a second axis. A receiving antenna is configured to sample global positioning system (GPS) data. A processor is configured to condition the data received from the first circuit board and GPS data to calculate wind data and altitude data at desired intervals. A wireless modem is configured to transmit the wind data and altitude data to an associated receiver through a transmitting antenna.

In still another embodiment, a method is provided for determining wind speed and wind direction measurements relative to altitude with a high ballistic coefficient wind sonde device. First, the wind sonde device is discharged from an aircraft at a predetermined altitude relative to a ground surface. The wind sonde device detects tilt and roll/heading data at predetermined intervals. The tilt and roll/heading data is processed, along with GPS-derived velocity data into an output signal having wind speed data, wind direction data and altitude data. The output signals are transmitted to a data receiver. A trajectory of cargo to be dropped from an aircraft is predicted from the data.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is a schematic side view of a wind sonde device according to one embodiment of the present disclosure;

FIG. 2 is a partial cross-sectional view of the wind sonde device of FIG. 1;

FIG. 3 is a schematic diagram illustrating the interaction of various components of the wind sonde device according to the present disclosure;

FIG. 4 is a schematic side view of another embodiment of a wind sonde device according to the present disclosure; and

FIG. 5 is a schematic side view of still another embodiment of a wind sonde device according to the present disclosure.

### DETAILED DESCRIPTION

It is to be understood that the detailed figures are for purposes of illustrating exemplary embodiments of the present disclosure only and are not intended to be limiting. Additionally, it will be appreciated that the drawings are not to scale and that portions of certain elements may be exaggerated for the purpose of clarity and ease of illustration.

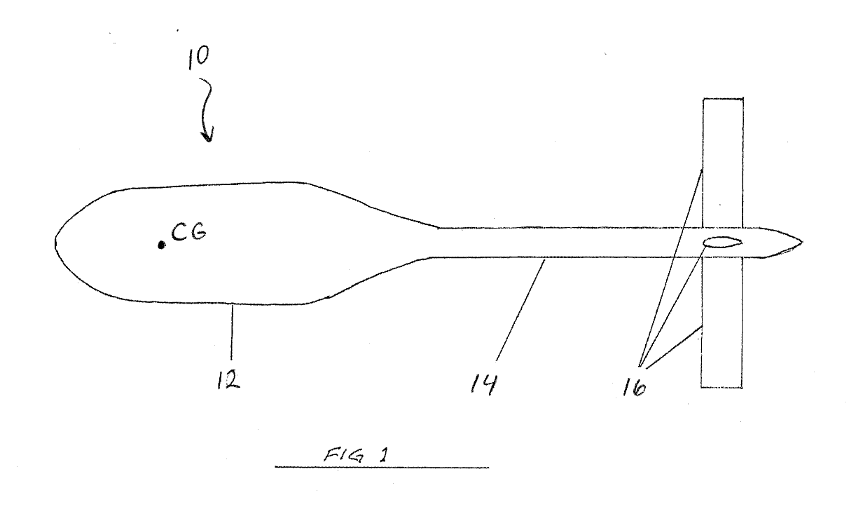

In accordance with the present disclosure, FIG. 1 illustrates the general configuration of a high ballistic coefficient wind sonde device 10 designed for receiving, sampling and transmitting wind and altitude data while traveling at a high velocity. The term “high ballistic coefficient” identifies that the device 10 travels quickly through the atmosphere. The wind sonde device 10 is designed to rely on the force of gravity to rapidly descend from an aircraft to the ground due to its aerodynamic shape and additional ballast as needed. The desired data sampled by the device 10 includes wind speed and wind direction as a function of altitude. The aerodynamic shape of the wind sonde 10 assists with travel through the atmosphere. The device includes a streamlined body 12 which is axially symmetric and is configured as a tapered cylinder. It has a slender tail 14 provided with stabilizing tail fins 16.

In the embodiment shown in FIG. 1, an arrangement of four equally spaced fins is illustrated (one of which cannot be seen) as being attached to or connected to the tail 14 adjacent its distal end. However, in another embodiment (not shown) three equally spaced fins could be used, as is known in the art. The device 10 can be made of known materials such as various thermoplastic materials, metals including aluminum or composite metals. The choice of materials used generally depends to some extent on the effect of the materials on an antenna configuration and its associated signal strength.

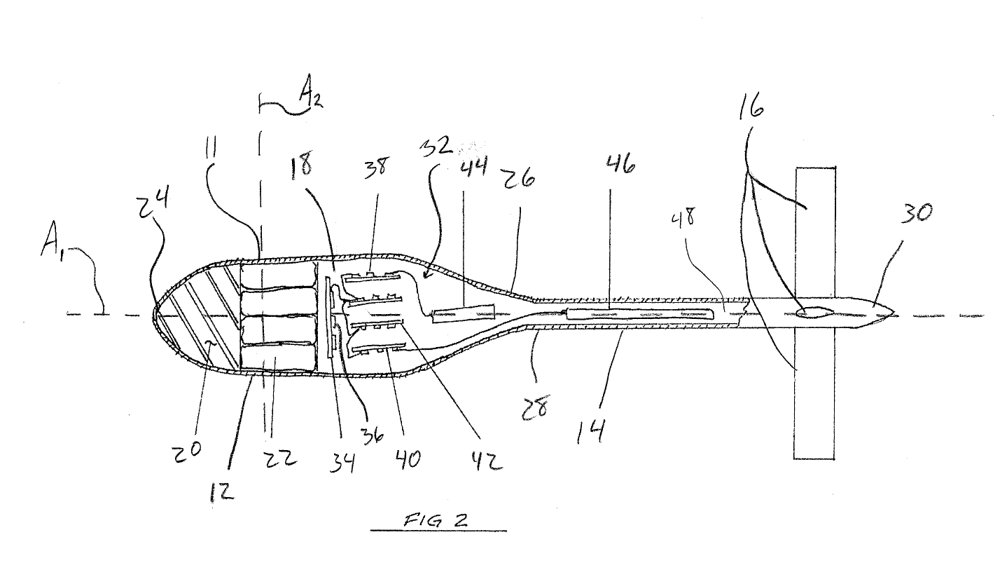

In the embodiment illustrated in FIG. 2, the streamlined body 12 has a housing portion 11 with an internal cavity 18 for containing internal components. The housing portion 11 of the body 12 has a bulbous generally cylindrical configuration with a forward larger radius than the elongated tail 14. The internal cavity includes a first end 24 or nose portion and an opposite second end 26. The tail 14 is elongated and includes a proximal end 28 and a distal end 30, the proximal end 28 of the tail 14 is attached to the second end 26 of the housing portion 11. The housing portion 11 and the tail 14 extend in a generally symmetric orientation along a longitudinal first axis A₁. Also, illustrated by FIG. 2 is a radial second axis A₂ that is generally normal to the longitudinal first axis A₁. The body of the device 10 has a high ballistic coefficient. In other words, the device 10 includes an additional ballast weight 20 and is shaped to overcome air resistance in free fall, meaning that the device will descend quickly.

One parameter that allows the device 10 to descend at high velocity is the ballistic coefficient. Generally, the ballistic coefficient [B] is characteristic of a body known to be a function of mass [M] over the cross sectional area of the body [A] modified by a drag coefficient [DC]. [B=M/(A*DC)]. In one embodiment, the ballistic coefficient of the device 10 is approximately 1.0 pounds per square inch (psi) or greater. The diameter of the device 10 is designed to fit in a range of different chaff/flare dispensers or on the tip of a 2.75 inch rocket. Therefore, the device 10 can have a diameter that varies between approximately 2 to 3 inches, and more particularly between 2.5 and 2.75 inches. As such, the drag coefficient can be approximately 0.25 and the weight of the device can be approximately 1.2 pounds. Notably, a device 10 with a ballistic coefficient of approximately 1.0 psi will descent at approximately 350 feet per second in a sea level density environment and approximately 475 feet per second at approximately 20,000 feet above a sea level density environment. The device 10 can be dropped or dispensed from an aircraft located in a range of altitudes but is particularly effective if dropped from an altitude below 25,000 feet above sea level.

A device 10 with a 1.0 psi ballistic coefficient that is dropped from 20,000 feet above sea level will descend at an average of about 400 feet per second to the ground. Thus, the descent will take approximately 50 seconds to impact. Low ballistic coefficient or low velocity drop wind sondes that descend at approximately 80 feet per second, take 250 seconds to impact. If a drop aircraft is traveling 120 knots it will travel approximately 1.9 miles in 50 seconds, it will also travel almost 10 miles in 250 seconds. Thus, the high ballistic coefficient drop sonde device 10 disclosed herein improves the accuracy of the calculations for the approximate trajectory of cargo to be dropped from an aircraft at a desired altitude by providing wind data in close proximity to the drop zone without requiring the aircraft to circle back for cargo release.

In one embodiment, the ballast weight 20 and batteries 22 are placed adjacent the nose portion 24 of the internal cavity 18. The nose portion 24 is located opposite the tail extension 14 of the device 10. The ballast weight 20 and batteries 22 also contribute mass and set the center of gravity CG (FIG. 1) near the nose of the wind sonde 10 so that it has high static stability and tends to rapidly tilt as necessary to align with the local flow over the body even as it descends through rapidly varying wind velocity.

The batteries 22 are in electronic communication with an electronic assembly 32 located within the internal cavity 18. The electronic assembly 32 includes a first circuit board 34 that includes at least one sensor 36 which assists in locating the position of the device relative to a reference axis. The first circuit board 34 and the at least one sensor 36 located thereon are positioned within the internal cavity 18 at a location which can be near the center of gravity of the device 10. In one embodiment, there are a plurality of sensors 36 provided such as a tilt sensor 54 and a roll/heading sensor 56. Two such tilt sensors may be employed. A second circuit board 38 is in electronic communication with the first circuit board 34 and is positioned within the internal cavity 18. The second circuit board 38 includes components configured to process global positioning system (GPS) signals received from satellites. A wireless modem board 40 and processor boards 42 are arranged within the internal cavity 18 and in electronic communication with a GPS receiving antenna 44 and a wireless transmitting antenna 46. In this embodiment, the wireless modem antenna 46 is located within an inner cavity 48 defined in the tail 14.

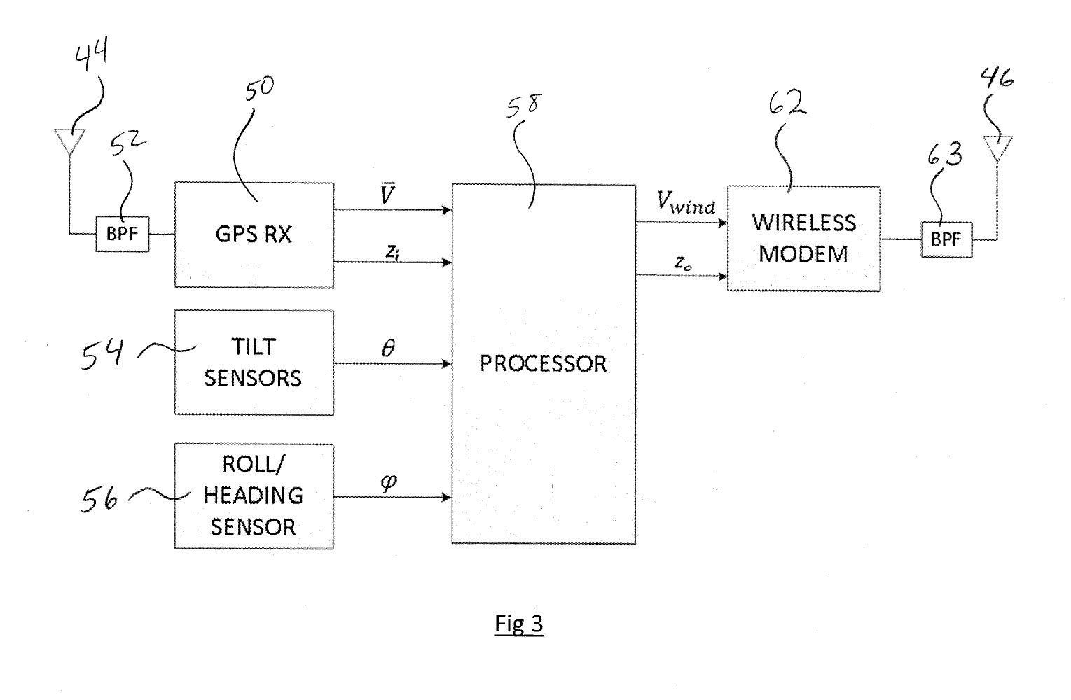

FIG. 3 illustrates a block diagram representation of one embodiment of the electronic assembly 32 of the device 10. A GPS receiver 50 can be mounted on the second circuit board 38 and is connected to the GPS antenna 44 through a band pass filter 52 to reduce interference from other transmitted signals. As illustrated by the diagram, the GPS receiver 50 generates a velocity vector signal (V) and an altitude signal (zᵢ). Additionally, the tilt sensors 54 generate a first angle signal (θ) and the roll/heading sensors 56 generate a second angle signal (φ). In one embodiment, the first angle signal (θ) is a measurement of the position of the first axis A₁ while the second angle signal (φ) is a measurement of the position of the second axis A₂. The velocity vector signal (V), altitude signal (zᵢ), first angle signal (θ) and second angle signal (φ) are communicated to a processor 58 located on one of the processor boards 42. The processor 58 conditions the data received by the GPS receiver 50, the tilt sensors 54 and the roll/heading sensors 56.

In one embodiment, the processor 58 applies a Kalman filter to condition the raw data signals received. As is known, the Kalman filter conditions the velocity vector signal (V) for lag due to the slip between wind from the atmosphere and the horizontal velocity of the device 10 due to its high velocity descent. Generally, Kalman filters are known in the art and comprise an algorithm that uses a series of measurements that are sampled over a period of time. The sampled measurements contain noise and other inaccuracies, and the algorithm is configured to reduce the noise by producing estimates of unknown variables that tend to be more precise than those that would be based on a single sampled measurement alone.

The processor 58 generates output signals including a wind velocity signal (V_{wind}) and an altitude signal (zₒ). These output signals are provided to a wireless modem 62 located on the wireless modem board 40 for transmission through the wireless transmitting antenna 46. The output signals can be passed through a band-pass filter 63 to reduce interference with other signals. Additionally, the output signals can be transmitted to more than one aircraft as desired in instances where a plurality of aircraft are involved in dropping cargo into the same drop zone. It should be appreciated that the wind sonde device can be dropped from an unmanned aerial vehicle (UAV) in addition to manned aircraft.

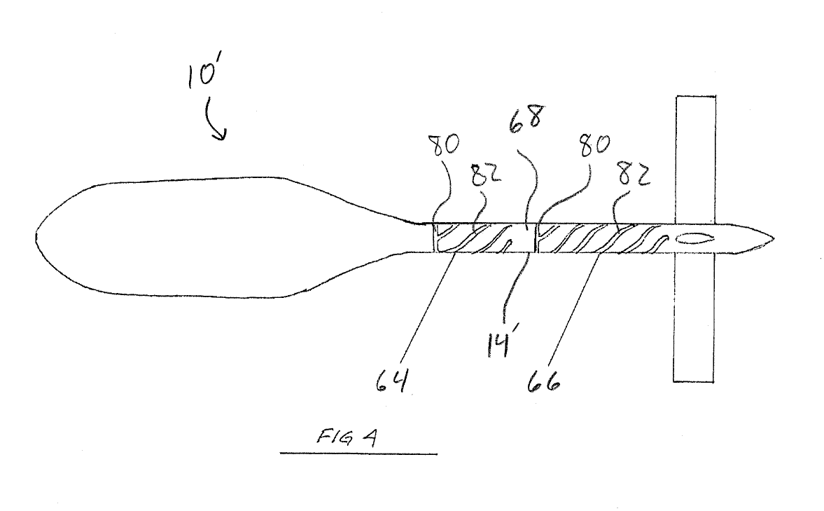

Various antenna arrangements are contemplated in this disclosure. One such arrangement is shown in FIG. 4. For ease of illustration, like components are identified by like numerals with a primed (′) suffix and new components are identified by new numerals. FIG. 4 illustrates one embodiment of an antenna orientation for a high velocity wind sonde device 10′. In this embodiment, a first quadrifilar helical antenna (QHA) 64 is located along a surface 68 of an elongated tail 14′ of the wind sonde and is in communication with a GPS receiver in the device. The first QHA 64 can be an L-band type antenna which receives GPS signals from associated GPS satellites. A second QHA 66 can be provided in a spaced manner along the surface 68 of the elongated tail and is in communication with a wireless modem in the device. The second QHA 66 can be an ultra-high frequency (UHF) type antenna which transmits output signals to associated aircraft identifying wind speed and wind direction relative to the altitude position of the device 10. The first and second QHA antennas 64, 66 assist to maximize signal strength between associated GPS satellites and a GPS receiver in the device as well as between the associated aircraft and a wireless modem in the device. In this embodiment, the QHA type antennas 64, 66 each include an annular member 80 with a plurality of legs 82 extending axially from the annular member 80 along the surface 68 of the tail 14′ in a generally helical geometric shape. Generally, QHAs produce and transmit radio waves having circular polarization. The location and geometry of this antenna orientation provides improved signal gain near the tail portion or aft hemisphere of the device 10′ and reduced signal strength on the ground where data might be intercepted by unauthorized users. Additionally, due to the circular polarization of the signals, cross-polarization losses can be avoided.

A trailing wire antenna (not shown) extending from the device 10′ is another example of a contemplated antenna orientation. In this embodiment, an additional known electrical component such as a duplexer will be required to allow the GPS receiver and wireless modem to share the antenna capabilities. However, this orientation may sample a “null” or otherwise insufficient directional signal strength.

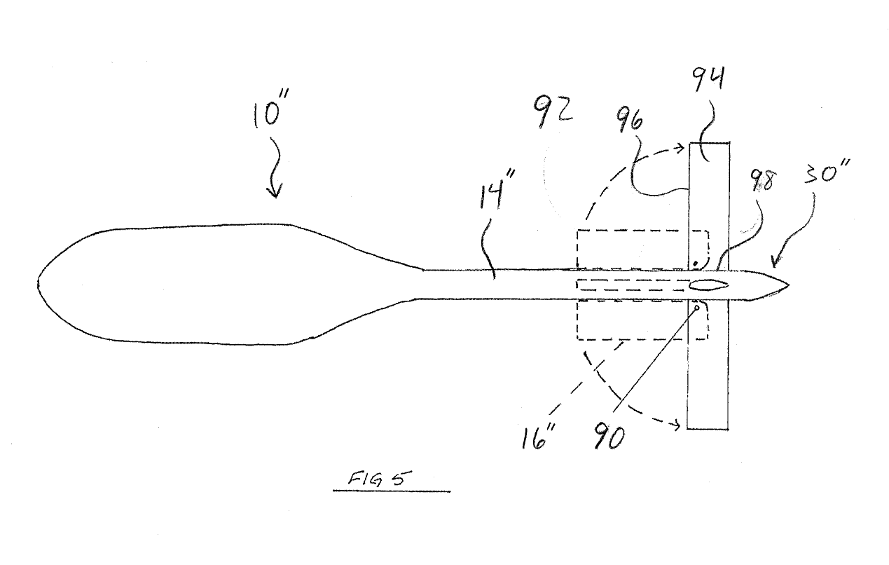

FIG. 5 illustrates still another embodiment of the wind sonde. In this embodiment, like components are identified by like numerals having a double primed (″) suffix and new components are identified by new numerals. In this embodiment, a plurality of fins 16″ are located adjacent a distal end 30″ of a tail portion 14″ of the device. Each fin 16″ is mounted via a pivot joint 90. The plurality of fins 16″ are configured to bias from a retracted position 92 to an extended position 94 as the device 10″ is descending through the atmosphere. In the retracted position 92, a front side 96 of the fins 16″ abuts against the tail 14″ and in the extended position 94, a bottom side 98 of the fins 16″ abuts against the tail 14″ near the distal end 30″. The drag force acting on the device 10, once it is released from the flying craft carrying it, is sufficient to bias the fins 16″ from the retracted position 92 to the extended position 94. In this one embodiment, the streamlined body is discharged from a tube shaped dispenser and a plurality of fins 16″ attached to the device 10″ are biased from a retracted position 92 to an extended position 94 after the discharging step. It is also contemplated, however, that a biasing member such as a spring (not shown) could be employed to assist in biasing the fins into the extended position. Foldable fins are advantageous for launching high velocity wind sonde devices from tubular launcher devices, such as chaff/flare launchers and sonabuoy tubes.

In still another embodiment, a method is provided for determining wind speed and wind direction measurements relative to altitude with a high ballistic coefficient wind sonde device. First, the high ballistic coefficient wind sonde device is discharged from an aircraft at a predetermined altitude relative to sea level. The wind sonde device detects raw data signals such as tilt and roll/heading data at predetermined intervals. In one embodiment, the raw data signals are detected at intervals of approximately every 100 feet as the device falls to the ground. The device also receives GPS data as it is descending from altitude. The data signals are processed into an output signal having wind speed data, wind direction data and altitude data and the output signals are transmitted to a data receiver to be configured to predict a desired trajectory of cargo to be dropped from an aircraft. The principle of operation for the method of determining wind speed and wind direction relative to altitude is that the tilt relative to vertical is a measure of the difference between ambient wind horizontal velocity and the horizontal velocity of the wind sonde 10. Thus, the tilt provides the “slip” correction in order to accurately determine the current wind speed and the current wind direction.

In one embodiment, the high velocity wind sonde device is discharged or launched from a tubular launcher device such as a rocket launcher mounted to the cargo-carrying aircraft in a desired direction of travel or flight path of the aircraft. This allows the wind sonde device to detect tilt and roll/heading data at a location ahead of the aircraft along the direction of travel. The wind speed data, wind direction data and altitude data can thereby be processed into an output signal that is representative of a desired cargo drop trajectory located ahead of the current position of the aircraft along the flight path. The output signal is then transmitted to the data receiver that is located on the aircraft. The aircraft can then drop cargo at a calculated location along the flight path such that the cargo efficiently and accurately follows the calculated trajectory to land in the drop zone. This method allows a single aircraft to make one pass over the desired drop zone while having accurate wind data to calculate desired cargo drop trajectory. This embodiment avoids the use of multiple aircraft or multiple passes over the drop zone which reduces the risk of aircraft detection.

It is to be appreciated that the high ballistic coefficient wind sonde embodiments disclosed herein are meant to be single use devices. However, it would also be possible to provide a small parachute in the tail of the device, which could deploy close to the ground to reduce the velocity of the device upon impact with the ground in case one wanted to reuse the device.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A high ballistic coefficient wind sonde device comprising:
a streamlined body including a first end, a second end, a longitudinal axis, and an internal cavity;
a tail including a first end, connected to the body second end and a second end, wherein the tail extends along the longitudinal axis of the body;
at least two fins mounted to the tail adjacent its second end;
an electronic assembly located in the internal cavity for generating wind and altitude data; and
a transmitting antenna mounted to at least one of the body and the tail for transmitting the wind and altitude data generated by the electronic assembly.

2. The high ballistic coefficient wind sonde device according to claim 1, wherein the streamlined body has a larger radius than the tail.

3. The high ballistic coefficient wind sonde device according to claim 1, wherein the at least one pair of fins are configured to bias from a retracted position to an extended position when the sonde device is in use.

4. The high ballistic coefficient wind sonde device according to claim 1 further comprising a receiving antenna mounted in or to at least one of the body and the tail for receiving global positioning system data.

5. The high ballistic coefficient wind sonde device according to claim 4, wherein the transmitting antenna and the receiving antenna comprise quadrifilar helical type antennas.

6. The high ballistic coefficient wind sonde device according to claim 4, wherein the receiving antenna comprises an L-band antenna.

7. The high ballistic coefficient wind sonde device according to claim 1, wherein the transmitting antenna comprises a UHF antenna.

8. The high ballistic coefficient wind sonde device according to claim 4, further comprising a processor for conditioning the data received by the receiving antenna and the at least one sensor into output data.

9. The high ballistic coefficient wind sonde device according to claim 8, wherein the processor applies a Kalman filter to condition the data received by the receiving antenna and the at least one sensor into output data.

10. The high ballistic coefficient wind sonde device according to claim 4, wherein the transmitting antenna transmits the output data through a wireless modem.

11. The high ballistic coefficient wind sonde device according to claim 1 further comprising at least one band pass filter in communication with at least one of the transmitting antenna and the receiving antenna to reduce signal interference.

12. A high velocity wind sonde device for receiving and transmitting data, comprising:
a streamlined body arranged in an axially symmetric orientation having an internal cavity for containing an electronic assembly for generating wind and altitude data, the body including:
a housing portion having a first end and an opposite second end such that a ballast weight is positioned towards the first end,
an elongated tail having a proximal end and a distal end, the proximal end of the tail being attached to the second end of the housing portion, the housing portion has a greater radius than the tail, and
a plurality of fins attached near the distal end of the tail,
the electronic assembly including a first circuit board having at least one tilt sensor for detecting an angle position of the body relative to a first axis and at least one roll/heading sensor for detecting an angle position of the body relative to a second axis;
a receiving antenna configured to sample global positioning system (GPS) data;
a processor for conditioning data received from the first circuit board and the receiving antenna to calculate wind data and altitude data at desired intervals; and
a wireless modem configured to transmit the wind data and altitude data to an associated receiver through a transmitting antenna.

13. The high ballistic coefficient wind sonde device of claim 12 wherein at least one of the first antenna and the second antenna are located along a surface of the tail.

14. The high velocity wind sonde device of claim 12 wherein the plurality of fins are configured to pivot from a retracted position to an extended position as the wind sonde device is dropped from a desired altitude.

15. The high velocity wind sonde device of claim 12 wherein the tilt sensor comprises at least one accelerometer having a longitudinal axis oriented generally perpendicular to a longitudinal axis of the streamlined body.

16. The high velocity wind sonde device of claim 12 wherein the streamlined body includes a ballistic coefficient of approximately 1.0 pound per square inch or greater.

17. A method of determining wind speed and wind direction relative to altitude with a high ballistic coefficient wind sonde device, the method comprising:
discharging the high velocity wind sonde device from an aircraft at a predetermined altitude relative to a ground surface;
detecting raw tilt and roll/heading data by the high velocity wind sonde device at predetermined intervals;
processing the tilt and roll/heading data into an output signal having wind speed data, wind direction data and altitude data;
transmitting the output signal to a data receiver; and
predicting a trajectory of cargo to be dropped from an aircraft from the data.

18. The method of claim 17 further comprising configuring the data after the transmitting step and before the predicting step.

19. The method of claim 17 further comprising receiving position signals from a GPS satellite before the processing step.

20. The method of claim 18 further comprising the step of extending a plurality of fins of the device from a retracted position to an extended position after the discharging step.

21. The method of claim 17 wherein the high velocity wind sonde device is discharged in a desired direction of travel of the aircraft and wherein wind speed data, wind direction data and altitude data ahead of the current position of the aircraft is processed and transmitted to the data receiver which is located within the aircraft.
